(19) United States
(12) Patent Application Publication
(10) Pub. No.: US 2019/0233164 A1
(43) Pub. Date: Aug. 1, 2019

(54) PLANTER STACKING RIBS

(71) Applicant: Suncast Technologies, LLC, Palm Beach Gardens, FL (US)

(72) Inventors: Dov Blitzer, Naperville, IL (US); Michael R. Vogler, Oswego, IL (US)

(21) Appl. No.: 15/884,059

(22) Filed: Jan. 30, 2018

(51) Int. Cl. B65D 21/02; A01G 9/02

(52) U.S. Cl. CPC B65D 21/0233; A01G 9/02

(57) ABSTRACT

A container, such as a planter, configured to prevent minimize damage resulting from storage of like like-shaped containers. The container may contain one or more components that prevent or minimize like-shaped containers stored or nested together from being stuck or wedged together in a manner which may result in damage to one or more components of the container. The container may include a bottom wall, at least one stacking rib configured to prevent or minimize a like-shaped container stored or nested together from being stuck or wedged together in a manner which may result in damage to one or more components of the container or the stored or nested like-shaped container, and including an outer side wall extending upwardly from the bottom wall and partially enclosing an inner area of the container.

### FIELD OF THE INVENTION

The present invention relates to containers; to stackable containers configured to be easily removable when stacked with one or more like-shaped storage containers; and more particularly, to containers having one or more stacking ribs for preventing the storage containers from sticking or wedging to each other when nested or stacked together.

### BACKGROUND OF THE INVENTION

Containers are known in the art. Such containers are designed to store materials or objects therein and have use in both commercial and residential settings. As such, many containers are produced to meet the demand for such objects and must be shipped to stores for residential use, or directly to businesses for commercial usage. Manufacturers of containers desire to minimize the volume of packaged containers for transport or shipment from the factory to minimize costs and space. In addition, retail stores selling containers desire to minimize the volume of packaged containers in order to minimize space associated with such product within the store. In order to do so, containers are often shipped or sold within a store in a stacked or nested arrangement where one container is stored within another.

While such arrangement serves a useful purpose in shipping and storage, it is not without its disadvantages. Containers that are stored in a nested position can result in the containers being stuck together. This may result from the transportation of the units, in which the notion of the transportation means results in the containers being squeezed together over time, or as a result of forces being applied thereto. This usually results in one or more portions of the two nested containers securing together in a tight fit. While being squeezed together might result simply in inconvenience for the user in separating nested containers, often one or more parts of the container may become damaged or warped when trying to separate the nested containers. This results in consumer dissatisfaction and retail loss, as the damaged products are returned or not bought by the consumer.

What is needed in the art is a container configured to prevent or minimize nested containers from being stuck together as a result of storage or transportation.

### SUMMARY OF THE INVENTION

The present invention relates to containers, such as planters, configured to prevent or minimize damage resulting from storage of like-shaped containers. The containers may contain one or more components that prevent or minimize like-shaped containers stored or nested together from being stuck or wedged together in a manner which may result in damage to one or more components of said container.

In an illustrative embodiment, the container may comprise a bottom wall and at least one stacking rib configured to prevent or minimize like-shaped containers stored or nested together from being stuck or wedged together in a manner which may result in damage to one or more components of the container. The container may further include an outer side wall extending upwardly from the bottom wall and partially enclosing an inner area of the container. The container may include at least one stacking rib that comprises a main body having an upper end positioned within an interior portion of said container. The stacking rib may be configured to prevent a like-shaped container with a corresponding stacking rib from being inserted and fitting into an opening within a bottom wall of the like-shaped container. The stacking rib may further comprise an appendage.

In another illustrative embodiment, the container for storing material therein comprises a bottom wall comprising a plurality of stacking ribs configured to prevent or minimize at least a portion or a like-shaped container stored or nested therein from being stuck or wedged together with the container in a manner which may result in damage to one or more components of the container or the nested or stacked like-shaped container.

Each of the plurality of stacking ribs contains a main body sized and shaped to extend outwardly away from the bottom wall and into an interior region of the container. The container also includes an outer side wall comprising one or more outer wall panels, each one of the one or more outer wall panels extend upwardly from the bottom wall and enclose an interior of the container. The stacking ribs contain a main body having an upper end surface sized and shaped to support at least a portion of a like-shaped container in a position raised above the bottom wall when a like-shaped container is stacked or nested with the container. The plurality of stacking ribs may comprise an appendage which is configured to extend outwardly away from said main body of said stacking rib. The appendage length may be configured to extend at least a portion, preferably the full length, of the stacking rib main body.

Accordingly, it is an objective of the invention to teach a container configured to prevent or minimize damage associated with stacking or nested like-shaped containers.

It is a further objective of the invention to provide a container configured to prevent or minimize at least a portion of a like-shaped container stored or nested therein from being stuck together with the container in a manner which may result in damage to one or more components of the container or the nested or stacked like-shaped container.

It is yet another objective of the invention to provide a container configured to prevent or minimize at least a portion of a like-shaped container stored or nested therein from being stuck together with said container in a manner which may result in damage to one or more components of the container or the nested or stacked like-shaped container.

It is a still further objective of the invention to provide a container configured to prevent or minimize at least a portion of a like-shaped container stored or nested therein from being wedged together with said container in a manner which may result in damage to one or more components of the container or the nested or stacked like-shaped container.

It is a further objective of the invention to teach a container configured to maintain a bottom wall of a nested or stacked, like-shaped container from contacting the bottom portion of the container bottom wall.

It is a further objective of the invention to provide a planter configured to prevent or minimize at least a portion of a like-shaped planter stored or nested therein from being stuck together with the planter in a manner which may result in damage to one or more components of the planter or the nested or stacked like-shaped planter.

It is yet another objective of the invention to provide a planter configured to prevent or minimize at least a portion of a like-shaped planter stored or nested therein from being stuck together with the planter in a manner which may result in damage to one or more components of the planter or the nested or stacked like-shaped planter.

It is a still further objective of the invention to provide a planter configured to prevent or minimize at least a portion of a like-shaped planter stored or nested therein from being wedged together with said container in a manner which may result in damage to one or more components of the planter or the nested or stacked like-shaped planter.

It is a further objective of the invention to teach a planter configured to maintain a bottom wall of a nested or stacked, like-shaped container from contacting the bottom portion of the planter bottom wall.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a side view of the planter with stacking ribs;

FIG. 2 is a perspective view of the planter with stacking ribs;

FIG. 3 is a bottom perspective view of the planter with stacking ribs;

FIG. 4 is a cross-sectional view of the planter with stacking ribs taken along lines 4-4 in FIG. 1;

FIG. 5 is a cross-sectional view of the planter with stacking ribs taken along lines 5-5 in FIG. 2;

FIG. 6 illustrates an embodiment of a stacking rib;

FIG. 7 illustrates an embodiment of a stacking rib; and

FIG. 8 illustrates two like-shaped planters with stacking ribs stacked or nested together.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

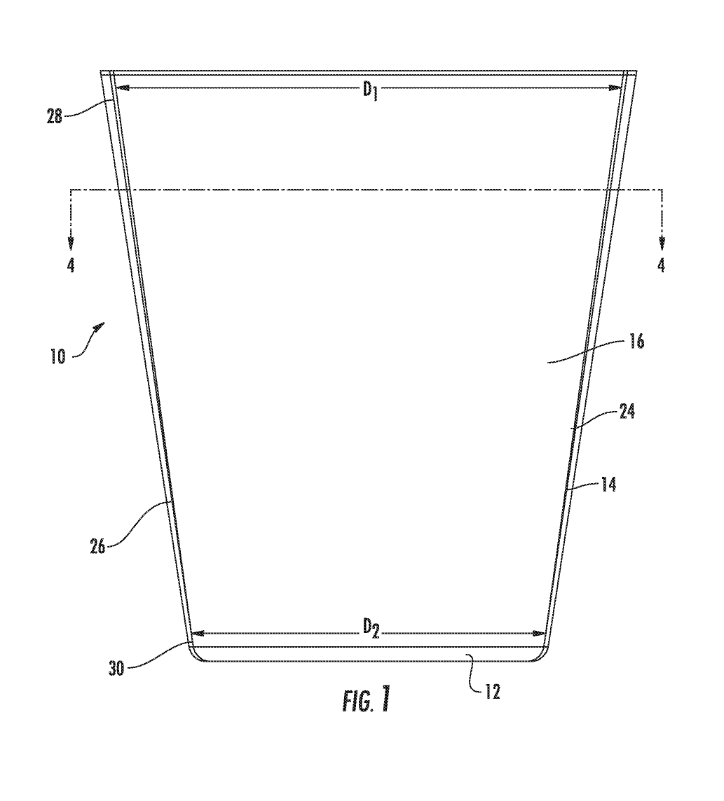

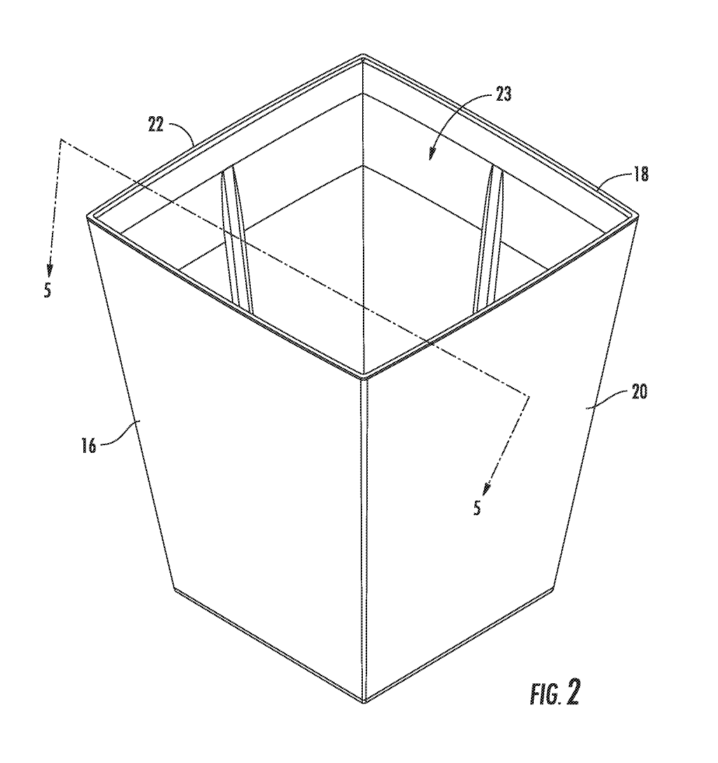

Referring to FIGS. 1-5, an example of a container having stacking ribs configured to prevent or minimize stored or nested containers from being stuck together in a manner which may result in damage is illustrated. The container described herein is a planter, referred to generally as planter having stacking ribs 10, which is configured for holding and storing materials and plants therein. Referring to FIG. 1, the planter having stacking ribs 10 comprises a bottom wall 12 and an outer side wall 14. The outer side wall 14 comprises a plurality of outer side wall panels 16, 18, 20 and 22, each arranged about and extending upwardly from the bottom wall 12 to provide a partially enclosed inner area compartment 23. The outer wall panels 16, 18, 20 and 22 may be individually constructed and secured together using chemical, i.e. glue, or mechanical, i.e. nails, mechanisms known to one of skill in the art to form the top wall. Alternatively, the outer wall 14 may be constructed as a single continuous unit. While the planter having stacking ribs 10 is illustrated assuming a generally square shape, such shape is illustrative only.

The outer site wall 16 comprises opposing tapered (towards the bottom wall 12) ends 24 and 26 so that the distance, D₁, between the ends 24 and 26 along the top of end 28 of outer side wall 16 is larger than the distance, D₂, along the bottom of end 30 of outer side wall 16. Each of the outer side wall panels 18, 20 and 22 contains the same features, thereby providing the planter having stacking ribs 10 with a profile having a tapered outer side wall. The tapered profile allows one or more planters having stacking ribs 10 to be stacked or nested together during shipping or storage.

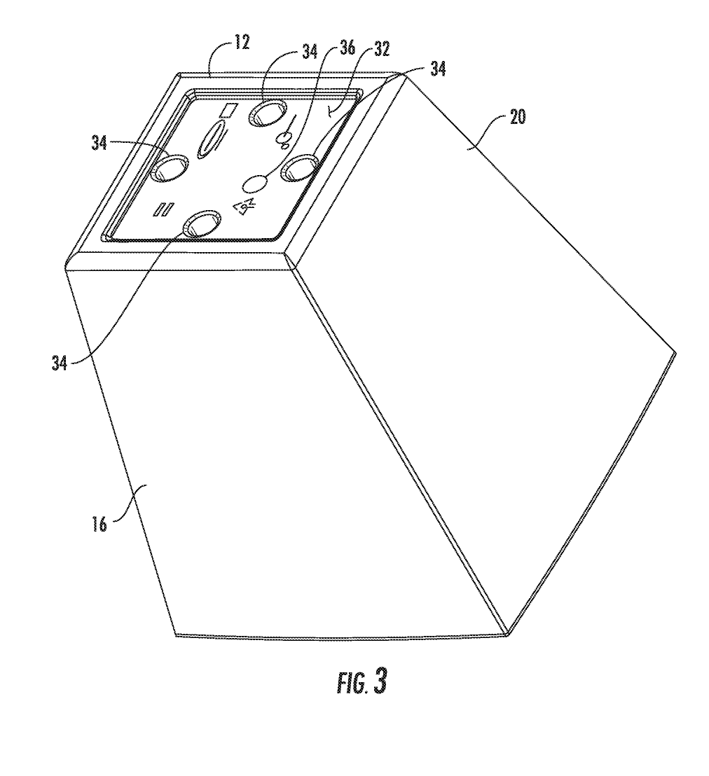

Referring to FIG. 3, the bottom wall 12 is illustrated assuming a generally square shape and sized and shaped to support the planter having stacking ribs 10. Cut or formed into the bottom wall surface 32 are stacking rib terminal ends 34. The bottom wall 12 may also contain a drain opening 36 sized and shaped to allow for fluid to flow out from the inner area compartment 23 of the planter having stacking ribs 10.

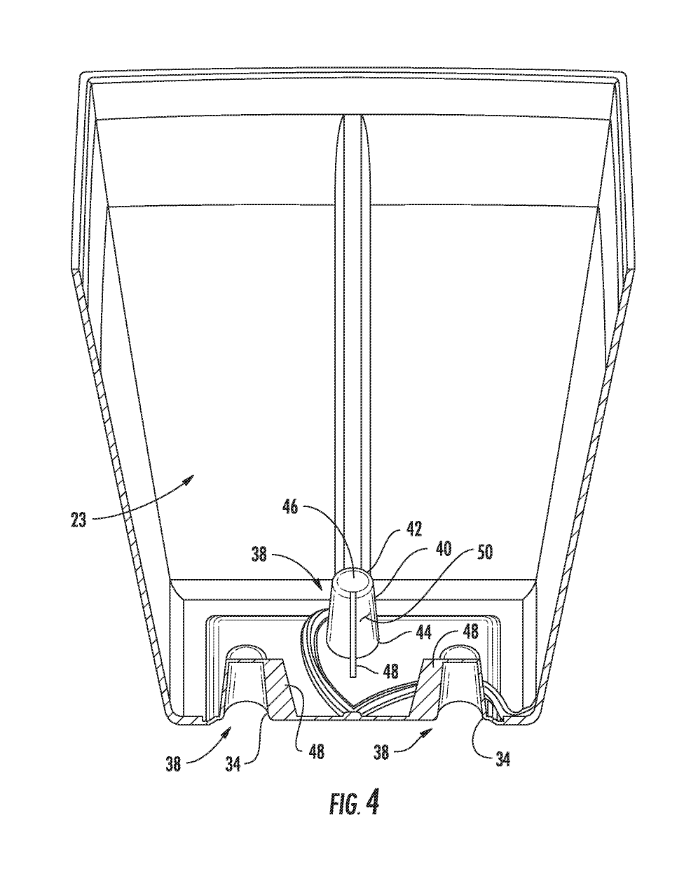

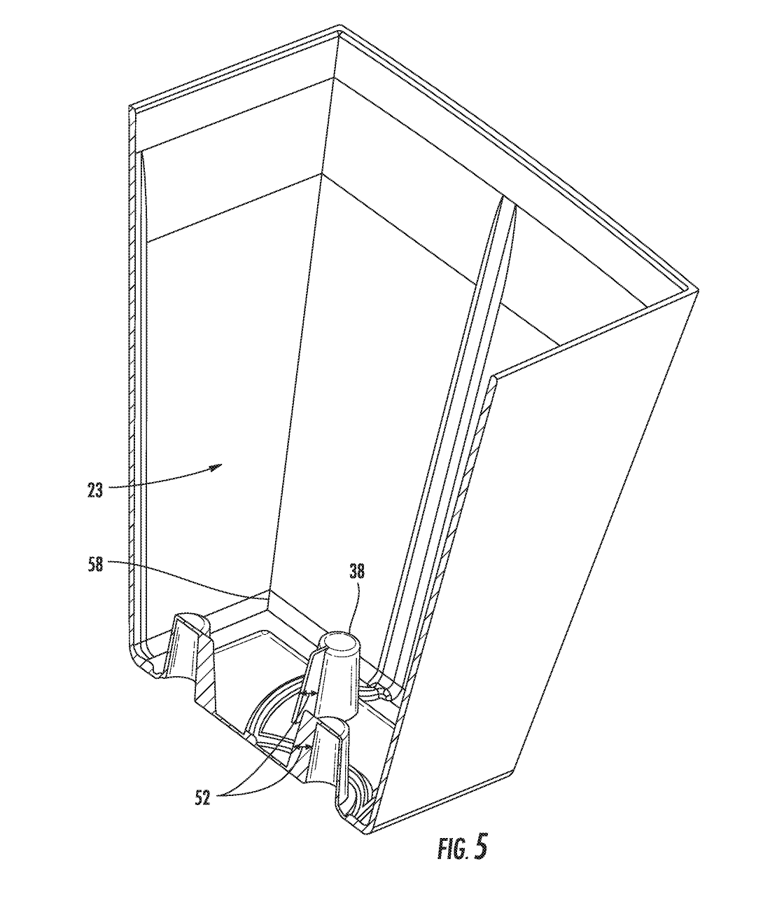

To prevent like-shaped planters having stacking ribs from sticking or wedging together when stacked or nested together, the planter having stacking ribs 10 comprises one or more stacking ribs 38. The planter haying stacking ribs 10 is configured to maintain one or more like-shaped nested or stacked planter having stacking ribs 10 placed within from sticking or wedging together. The stacking ribs 38 comprise a main body 40 having a first upper end 42 and a second, lower end 44. The second lower end 44 terminates in the stacking rib terminal end 34. As illustrated in FIG. 4 or FIG. 5, the stacking rib terminal end 34 is shown as an opening. The stacking rib main body 40 extends upwardly from the bottom wall 12, into the inner area compartment 23. The upper surface 46 is sized and shaped to support at least a portion of the bottom wall 12 of a like-shaped planter having stacking ribs 10 stacked on top.

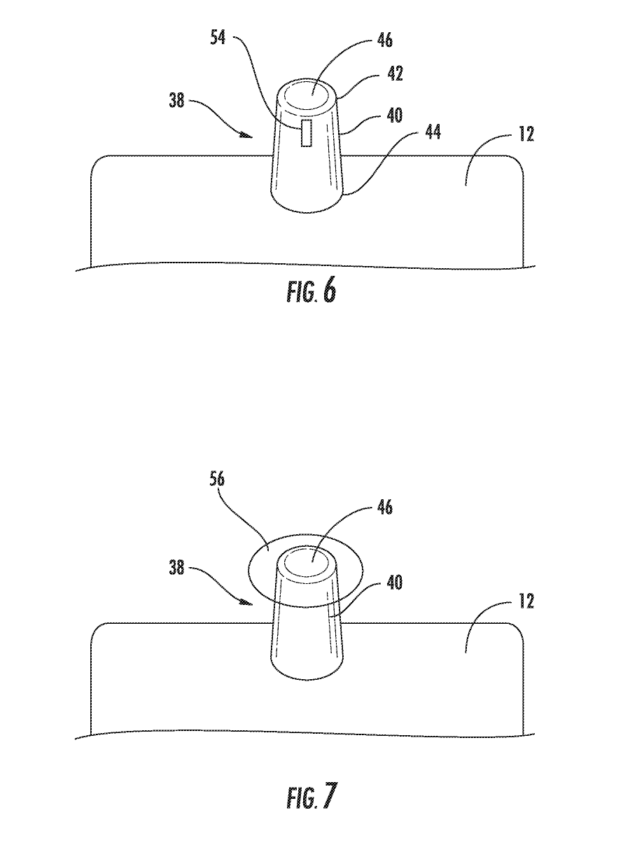

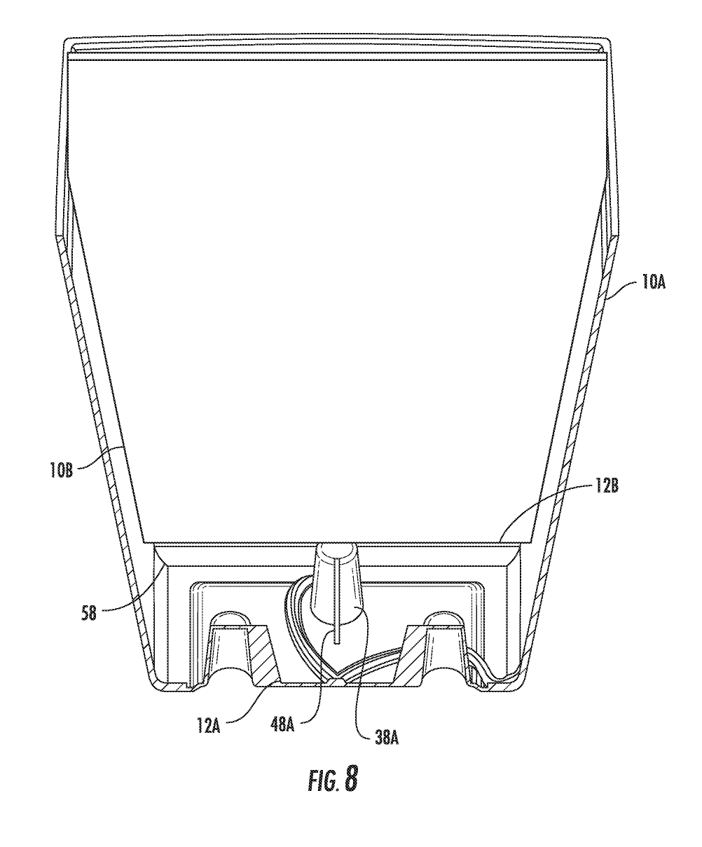

The stacking rib main body 40 further comprises an appendage, illustrated herein as a fin 48. The fin 48 has a generally planar body which extends out, away from the outer surface 50 of the stacking rib main body 40. The length of the fin 48 extends the entire length of the stacking rib main body 40, from the first upper end 42 and/or the upper surface 46 to the second, lower end 44 and/or stacking rib terminal end 34. Alternately, the length of the fin 48 may extend less than the entire length of the stacking rib main body 40. The length of the fin extending out away from the main body 40, see reference number 52, FIG. 5, is a sufficient distance to ensure that the stacking rib main body 40 does not fit within a stacking rib terminal end 34 of a like-shaped planter having stacking ribs 10 when two or more planters having stacking ribs 10 are stacked together. While the stacking rib main body 40 illustrates the use of an appendage fin, other appendages that extend a sufficient distance from the main body 40 and are sized and shaped to ensure that the stacking rib main body 40 does not fit within a stacking rib terminal end 34 of a like-shaped planter having stacking ribs 10 when two or more planters having stacking ribs 10 are stacked together may be used. FIG. 6 provides an illustrative example of a stacking rib main body 40 in which the appendage is a ball-shaped member 54. Alternatively, the appendage may be a circular disc 56.

FIG. 8 illustrates two like-shaped planters having stacking ribs 10 (outer planter) and 10B (inner planter) in a stacked or nested configuration. As illustrated, the bottom wall 12B of the planter having stacking ribs 10B rests on the stacking rib 38A of the planter having stacking ribs 10A. As shown, the bottom wall 12B is elevated from the bottom wall 12A of planter having stacking ribs 10A. In this arrangement, the bottom wall 12B of the planter having stacking ribs 10B is prevented from contacting one or more portions of the bottom wall 12A, or associated corner(s) (i.e. area where two outer wall panels meet), see 58, FIGS. 5 and 8, of planter having stacking ribs 10A. In addition, the profile of the stacking rib 38A with appendage 48A is sufficient in size or orientation, i.e. how far the appendage extends away from the main body, to prevent the stacking rib 38A from being inserted into an opening on a bottom wall of a like-shaped and stacked or nested container, or from engaging with, such as being placed into, a like-shaped stacking rib associated with a stacked or nested like-shaped container. This prevents coupling or wedging of the stacking rib 38A with a stacking rib 38 associated with the planter having stacking ribs 10B. By preventing or limiting such contact, planters having stacking ribs 10A and 10B are prevented from, or less likely to be secured or wedged together. As such, a user may remove stacked or nested containers without warping, deforming or damaging one or more components of said container or said stored or nested like-shaped container.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A container for storing material therein comprising:
a bottom wall; and
at least one stacking rib configured to prevent or minimize a like-shaped container stored or nested together from being stuck or wedged together in a manner which may result in damage to one or more components of said container or said stored or nested like-shaped container.

2. The container for storing material therein according to claim 1 further including an outer side wall extending upwardly from said bottom wall and partially enclosing an inner area of said container.

3. The container for storing material therein according to claim 3 wherein said outer side wall comprises a tapered portion.

4. The container for storing material therein according to claim 3 wherein said outer side wall comprises a plurality of side wall panels.

5. The container for storing material therein according to claim 1 wherein said at least one stacking rib comprises a main body having an upper end positioned within an interior portion of said container.

6. The container for storing material therein according to claim 5 wherein said main body upper end comprises a surface sized and shaped to support at least a portion of said like-shaped container in a position raised above said bottom wall when said like-shaped container is stacked or nested with said container.

7. The container for storing material therein according to claim 1 wherein said at least one stacking rib is configured to prevent said at least one stacking rib from insertion into an opening within a bottom wall of a like-shaped container or from engaging with a like-shaped stacking rib associated with said like-shaped container.

8. The container for storing material therein according to claim 7, wherein said. at least one stacking rib comprises an appendage.

9. The container for storing material therein according to claim 8 wherein said appendage is a fin, said fin extending outwardly away from said at least one stacking rib main body.

10. A container for storing material therein comprising:
a bottom wall comprising a plurality of stacking ribs configured to prevent or minimize at least a portion of a like-shaped contaner stored or nested therein from being stuck or wedged together with said container in a manner which may result in damage or deformation to one or more components of said container or said nested or stacked like-shaped container, each of said plurality of stacking ribs contain a main body sized and shaped to extend outwardly away from said bottom wall and into an interior region of said container; and
an outer side wall comprising one or more outer wall panels, each one of said one or more outer wall panels extend upwardly from said bottom wall and partially enclosing an interior of said container.

11. The container for storing material therein according to claim 10 wherein said stacking ribs contain a main body having an upper end surface sized and shaped to support at least a portion of a like-shaped container in a position raised above said bottom wall when said like-shaped container is stacked or nested with said container.

12. The container for storing material therein according to claim 10 wherein each of said plurality of stacking ribs comprise an appendage.

13. The container for storing material therein according to claim 12 wherein said appendage extends outwardly away from said main body of said stacking rib.

14. The container for storing material therein according to claim 13 wherein said appendage has a length which extends at least a portion of said stacking rib main body.

15. The container for storing material therein according to claim 12 wherein said appendage is a fin, said fin extending outwardly away from said stacking rib main body.

16. The container for storing material therein according claim 12 wherein said fin has a length which extends to at least a portion of said stacking rib main body.
